(19) United States
(12) Patent Application Publication
(10) Pub. No.: US 2004/0027782 A1
(43) Pub. Date: Feb. 12, 2004

(54) Electrical double-layer capacitor

(76) Inventors: Werner Erhardt, Ballendorf (DE); Christoph Weber, Heidenheim (DE)

Correspondence Address: FISH & RICHARDSON PC, 225 FRANKLIN ST, BOSTON, MA, 02110, US

(21) Appl. No.: 10/433,718

(22) PCT Filed: Dec. 5, 2001
(86) PCT No.: PCT/DE01/04570

(30) Foreign Application Priority Data
Dec. 6, 2000 (DE) 100 60 653.9

(51) Int. Cl. H01G 4/35

(52) U.S. Cl. 361/302

(57) ABSTRACT

The invention relates to an electrical double layer capacitor with two superimposed electrode layers (2, 3). These electrode layers (2, 3) are separated by an electrically insulating dividing layer (1). At least one of the electrode layers (2, 3) is applied to the dividing layer (1) by means of a coating process. The advantage of the capacitor of the invention is that the dividing layer (1) coated by the electrode layer (2, 3) allows for improved volume utilization.

The invention relates to an electrical double layer capacitor with two superimposed electrode layers separated by an electrically insulating dividing layer.

Capacitors of the type noted above are known, in which a dividing layer and electrode layers represent separate elements that are stacked together and then coiled. In this case, the function of the dividing layer is to prevent short circuits. To produce capacitors for use with high amounts of electrical energy, the electrodes are optimized by substantially enlarging their surface area. This is accomplished using, e.g., electrode layers made of carbon, by activating the surface. Electrode layers made of carbon can, for example, be inserted into the capacitor in the form of pieces of fabric.

The drawback of capacitors known in the art is that they utilize volume poorly. To a person skilled in the art, volume utilization refers to the capacitance made available relative to the volume of the capacitor. Because the electrode layers and the dividing layer are separate elements, they must be made of a material having a certain minimum stability. Otherwise, the individual layers could not be stacked together and then processed further. This minimum stability is achieved by providing an appropriate minimum stability of, for example, the pieces of carbon fabric. Volume utilization worsens when the individual layers are very thick.

In cases where the layer stack is coiled into a roll, there is also the risk that faults may form in individual layers during coiling, resulting in hollow spaces in the capacitor coil, which is also detrimental in terms of volume utilization.

Therefore, the goal of the present invention is to specify a capacitor of the type noted above that utilizes volume better.

The invention specifies an electrical double layer capacitor having two superimposed electrode layers. An electrically insulating dividing layer separates the electrode layers. At least one of the electrode layers is applied to the dividing layer by means of a coating process.

An advantage of a capacitor according to the invention is that at least one electrode layer and the dividing layer are combined in a single device. The electrode layer is an integral component of this device. Because this single electrode layer applied to the dividing layer by means of the coating process is no longer a separate element of the capacitor, the electrode layer can be designed to have a significantly thinner layer thickness. In particular, a high inherent mechanical stability of the electrode layer is no longer necessary. By means of the invention, it is possible, e.g., to use electrode layers that are <500 μm, preferably <100 μm thick.

Another advantage of the capacitor of the invention is that the electrode layers no longer rest on the dividing layer as a separate component, but instead are applied by means of a coating process. As a result, the electrode layer is disposed at a very small distance from the dividing layer, increasing the capacitance between the electrode layers.

Because it is possible to achieve thinner layer thickness, and as a result of the direct contact between the electrode layer and the dividing layer, the inventive capacitor utilizes volume better.

In an advantageous embodiment of the invention, at least one of the electrode layers comprises particles or fibers that are applied to the dividing layer. The use of particles or fibers makes it possible to achieve an especially large surface area for the electrode layer, which is necessary for high-capacitance capacitors. The use of fibers, specifically, for the electrode layer is advantageous in that the electrode layer can be contacted more effectively from a side facing away from the dividing layer. This is because fibers, provided they are suitably disposed, pass through the entire thickness of the electrode layer in one piece, so that negative effects of particle size can be avoided.

In addition, it is especially advantageous when one of the electrode layers is made of a powder mixed with a suitable adhesive. The adhesive provides for cohesion of the powder within the electrode layers. Materials that can be used as adhesives include those that are used to coat aluminum electrodes, such as polyvinyl difluoride. It is also possible to embed carbon powder in a polymer matrix.

The adhesive mixed with the powder can, for example, be applied to the dividing layer by means of doctoring or using printing processes, such as silk-screen printing.

Another advantageous means of applying the electrode layer to the dividing layer includes electrostatic precipitation of the electrode layer on to the dividing layer. Electrostatic precipitation of the electrode layer is advantageous in that adhesives or binders are not necessary. This increases the long-term stability of the capacitor without subjecting it to the aging that occurs with an adhesive or the decrease in adhesive strength resulting from such aging.

In another advantageous embodiment of the invention, contacting the electrode layer can be accomplished by providing a coating with an electrically conductive contact layer on the side facing away from the dividing layer. Such an electrically conductive contact layer can, for example, consist of a noble metal, such as silver or gold, or aluminum. In general, all electrically conductive materials are suitable that are resistant to the ion-containing solvents used in electrochemical double layer capacitors and to the potentials present at the electrodes, or become resistant through the formation of a protection layer. The advantage of the contact layer is that it provides for improved contacting of the electrode layer. The thickness of the contact layer is, advantageously, between 1 and 20 μm, for example.

In another advantageous embodiment of the invention, the contact layer can be produced by means of vacuum metallization or spray application. Spray application of the contact layer can, in particular, be accomplished using the method known to the person skilled in the art under the name “schooping”. The application of the contact layer by means of vacuum metallization is particularly advantageous in connection with an electrostatically applied electrode layer, because this results in adequate adhesion of the electrode layer to the dividing layer and eliminates the need for additional adhesives. Furthermore, the contact layer can also promote the cohesion of the components of the electrode layer.

To realize an electrochemical double layer capacitor, it is advantageous when at least one of the electrode layers comprises carbon or another material suitable for use with an electrochemical double layer capacitor. Another such material is, for example, an electrically conductive polymer or a metal oxide, such as ruthenium oxide or nickel oxide. In terms of all the materials for the electrode layers that are suitable for use with an electrochemical double layer capacitor, it is important that they feature a charge storage mechanism, which is known to the person skilled in the art under the terms “pseudo-capacitance” or “double-layer capacitance.”

By making one of the electrode layers porous, the surface of the electrode layer, and thus the capacity of the double layer capacitor, can be enlarged. This also increases volume utilization. If the electrode layer is made of carbon, activating the carbon can enlarge the surface. At the same time, pores are created in the carbon. It is possible to achieve this by chemical means.

To design the capacitor of the invention for larger currents, it is advantageous if at least one of the electrode layers is covered with a feed layer having a high current-carrying capacity. An example of a material that can be used as this feed layer is an aluminum foil between 10 and 100 μm thick.

To realize an electrochemical double layer capacitor, it is also advantageous if the dividing layer is a porous layer saturated with an ion-containing fluid. This makes it possible to realize the typical structure of an electrochemical double layer capacitor. Examples of materials that can be used as a porous layer include paper or a porous plastic foil. The ion-containing fluid can be acetonitrile, for example.

In another advantageous embodiment of the invention, two dividing layers are disposed between the electrode layers. Each of the electrode layers is applied to exactly one of the dividing layers by means of a coating process. As a result of the application of the electrode layers to two different dividing layers, the risk of a short circuit between the electrode layers caused by the pores in the dividing layer can be reduced. Furthermore, dividing layers coated only on one side are more easily manufactured, because coating the back of the dividing layer is not necessary. Furthermore, dividing layers coated on only one side are also easier to work with, for example, when winding the layers into a coil.

The contact layers can also be designed, with respect to their thickness, in such a way that no feed layer may be necessary.

The following describes the invention in greater detail on the basis of embodiment examples and the corresponding figures.

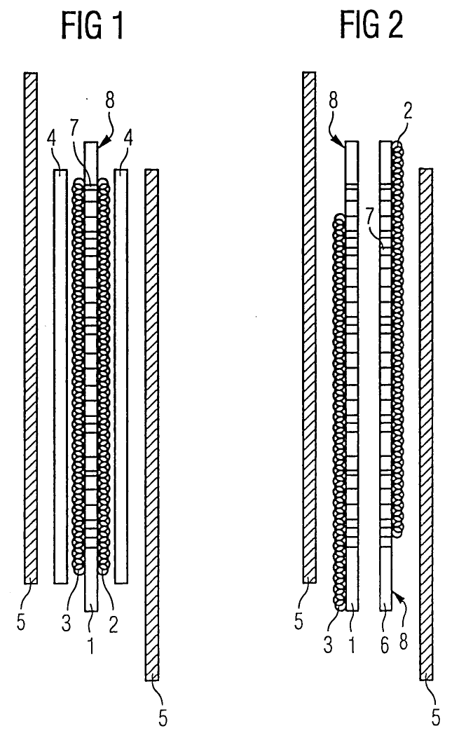

FIG. 1 depicts, in exemplary fashion, an inventive electrochemical double layer capacitor in schematic cross-section.

FIG. 2 depicts, in exemplary fashion, another inventive electrochemical double layer capacitor in schematic cross-section.

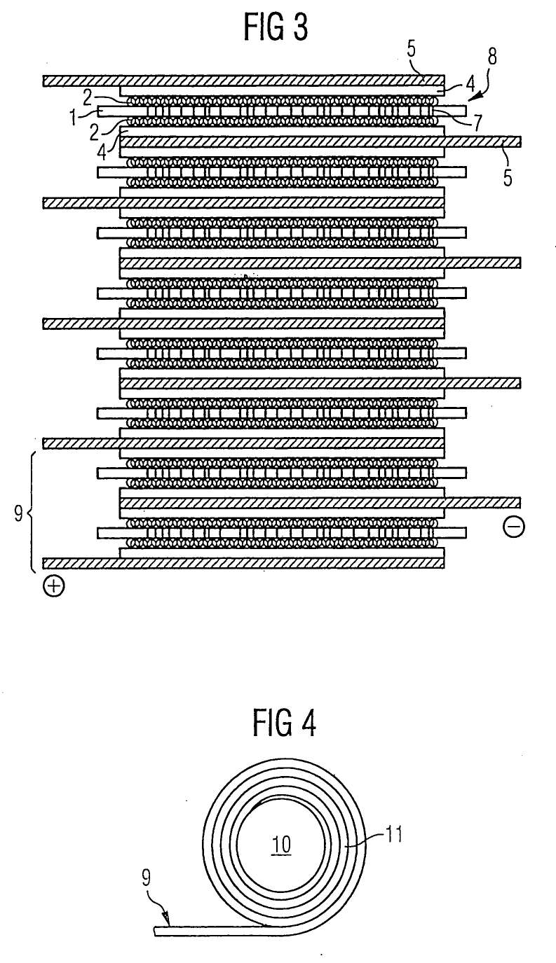

FIG. 3 depicts the coil of an inventive electrochemical double layer capacitor in schematic cross-section.

FIG. 4 depicts the coil of an inventive electrochemical double layer capacitor in a lateral view.

FIG. 1 depicts a capacitor with two electrode layers 2, 3 separated by a dividing layer 1. The dividing layer 1 can be a porous plastic foil between 20 and 100 μm thick, for example. A thickness of 30 μm is especially suitable. The electrode layers 2, 3 are applied to the dividing layer 1 by means of a coating process. Exposed edges 8 not covered by electrode layers 2, 3 are provided on the edges of the dividing layer 1. These exposed edges 8 provide insulation between the electrode layers 2, 3. The extended creep path can help reduce the risk of a short circuit between the electrode layers 2, 3.

Contact layers 4 are applied to the surface of the electrode layers 2, 3 by means of vacuum metallization. In addition, a feed layer 5 is disposed on each contact layer 4. The distance between the feed layer 5 and the contact layer 4 is not drawn to scale in FIG. 1. This is because, in a capacitor as depicted in FIG. 1, the objective is to achieve the densest possible packing of the layers on top of one another. As depicted in FIG. 1, the feed layers 5 are designed in such a way that they protrude over the layer stack at the top and/or bottom, and therefore can be easily contacted from the exterior using schoop layers, for example.

FIG. 2 depicts a capacitor. The reference numbers in FIG. 2 correspond to the reference numbers in FIG. 1. The structure of the capacitor shown in FIG. 2 is essentially identical to that shown in FIG. 1. The capacitor shown in FIG. 2 differs from that shown in FIG. 1 in that an additional dividing layer 6 is disposed between the electrode layers 2, 3. An electrode layer 2, 3 is applied, in each instance, to each of the dividing layers 1, 6 using a coating process, such as doctoring a powder mixed with a binder.

Because of the second dividing layer 6 between the electrode layers 2, 3, one of the two exposed edges 8, which are needed in FIG. 1, can be eliminated on each side of the dividing layers 1, 6. This is because the double layer disposed between the electrode layers 2, 3 is twice as thick in FIG. 2 as the corresponding single layer in FIG. 1. As a result, the creep path between the two electrode layers 2, 3 is extended. The volume utilization of the capacitor is further increased as a result of the omission, in each instance, of one exposed edge 8 on each side of the dividing layers 1, 6.

FIG. 3 depicts, in cross-section, the coil 11 produced by applying the winding process depicted in FIG. 4 to several stacked layers 9. Four stacked layers 9 are shown. Each of these layers 9 corresponds to a structure produced by means of double stacking of the arrangement depicted in FIG. 1.

FIG. 4 depicts the winding of a layer 9, using a winding spindle 10, to form a coil 11 of the type necessary for cylindrically symmetrical arrangements.

The invention is not limited to the embodiment examples described, but instead is defined in its most general form by claim 1.

1. Electrical double layer capacitor
with two superimposed electrode layers (2, 3) separated by an electrically insulating dividing layer (1),
in which at least one electrode layer (2, 3) is applied to the dividing layer (1) by means of a coating process.

2. Capacitor according to claim 1,
in which at least one electrode layer (2, 3) comprises particles or fibers applied to the dividing layer (1).

3. Capacitor according to claim 1 or 2,
in which at least one electrode layer (2, 3) is made of a powder mixed with a suitable adhesive.

4. Capacitor according to claim 1 or 2,
in which the dividing layer (1) is electrostatically coated with an electrode layer (2, 3).

5. Capacitor according to claims 1 through 4,
in which the side of at least one electrode layer (2, 3) facing away from the dividing layer (1) is coated with an electrically conductive contact layer (4).

6. Capacitor according to claim 5,
in which the contact layer (4) is produced by means of vacuum metallization or spray application.

7. Capacitor according to claims 1 through 6,
in which at least one electrode layer (2, 3) comprises carbon or another material suitable for an electrochemical double layer capacitor.

8. Capacitor according to claim 7,
in which at least one electrode layer (2, 3) comprises an electrically conductive polymer or a metal oxide.

9. Capacitor according to claims 1 through 8,
in which at least one electrode layer (2, 3) is porous.

10. Capacitor according to claims 1 through 9,
in which at least one electrode layer (2, 3) is covered with a feed layer (5) having a high current-carrying capacity.

11. Capacitor according to claims 1 through 10,
in which the dividing layer (1) is a porous layer saturated with an ion-containing solution.

12. Capacitor according to claims 1 through 11,
in which two dividing layers (1, 6) are disposed between the electrode layers (2, 3), and in which each electrode layer (2, 3) is applied to a dividing layer (1, 6) by means of a coating process.

13. Capacitor according to claims 1 through 12,
in which an electrode layer (2, 3) is less than 500 μm thick.
